(19) United States
(12) Patent Application Publication
(10) Pub. No.: US 2026/0303522 A1
(43) Pub. Date: Oct. 1, 2026

(54) SYSTEMS AND METHODS FOR DISTRIBUTING NETWORK TRAFFIC BASED ON NETWORK NODE ASSIGNMENTS TO NETWORK DOMAINS

(71) Applicant: Capital One Services, LLC, McLean, VA (US)

(72) Inventors: Rais KAZI, Murphy, TX (US); Rakeshreddy KESIREDDY, Frisco, TX (US); Albert NABIULLIN, McLean, VA (US); Sikkandar SIKKANDAR PACKIAM, Prosper, TX (US); Simone FEROCE, Cedar Park, TX (US); Raghuram VIJAYARAGHAVAN, Prosper, TX (US); Samer FAIZI, Allen, TX (US)

(73) Assignee: Capital One Services, LLC, McLean, VA (US)

(21) Appl. No.: 19/094,782

(22) Filed: Mar. 28, 2025

(51) Int. Cl. H04L 45/00

(52) U.S. Cl. CPC H04L 45/46

(57) ABSTRACT

A device may execute a first process for clustering of a plurality of network nodes of a network using a first configuration of clustering parameters. The first process is to identify a plurality of first clusters of network nodes and a plurality of first un-clustered network nodes. The device may determine one or more clusters, of the first clusters, to remove from the first clusters, and reconfigure the first clusters to remove the cluster(s), and the first un-clustered network nodes to include network nodes of the cluster(s). The device may execute a second process for clustering of the first un-clustered network nodes using a second configuration of clustering parameters. The second process is to identify a plurality of second clusters of network nodes, and a plurality of second un-clustered network nodes. The device may assign the first clusters and the second clusters to a plurality of network domains.

### BACKGROUND

The density of network nodes generally plays a role in overall performance, scalability, and resource efficiency in a network. Networks with high node density can facilitate lower latency and increased redundancy, making them well-suited for applications requiring real-time data processing, such as cloud computing, Internet-of-Things (IoT), and edge computing. Conversely, sparse node distributions may be advantageous in scenarios where energy efficiency is a priority. The dynamic nature of network traffic, influenced by the demand of user devices, geographic distribution, and application requirements, often leads to imbalances where certain domains or logical partitions of a network become congested while others remain underutilized, creating challenges in managing traffic loads effectively.

### SUMMARY

Methods and systems are described herein for novel uses and/or improvements to distributing network traffic in a network. As one example, methods and systems are described herein for distributing network traffic based on forming variable density clusters of network nodes and assigning the clusters to network domains of the network.

An operational network (e.g., a computer network) may include interconnected network nodes. For example, these network nodes may include data centers, servers, and/or other systems that facilitate network traffic. Efficient management of network traffic is a factor for maintaining optimal network performance, reducing latency, and ensuring reliable data communication. In some cases, clusters (e.g., groups) of network nodes (e.g., data centers) may be assigned to network domains (e.g., cloud computing regions) and network traffic for these network domains may be processed by respective clusters of network nodes. Accordingly, performance in the network is affected by how efficiently network nodes are clustered. For example, failing to account for variable network node density, and for both sparse clusters and dense clusters, can result in inefficient cluster formation that may lead many network nodes to be improperly clustered or un-clustered. This inefficient clustering of network nodes can result in inefficient use of network resources or excessive consumption of network resources, thereby causing higher latency, service outages, and/or poor network performance and uptime due to an inefficient allocation of network resources.

Methods and systems disclosed herein provide efficient clusters of network nodes of a network, which can be assigned to network domains to facilitate efficient utilization of network resources. In some embodiments, a system may use a multi-pass clustering approach based on a variable-density-based clustering to identify clusters of network nodes. For example, the multi-pass clustering may begin with executing a first clustering process of network nodes using a specific configuration of clustering parameters. This clustering may identify a set of first clusters and un-clustered network nodes. The system then determines which clusters to remove based on certain criteria, such as the longest path between network nodes within a cluster. The removed clusters and associated network nodes are returned to the pool of un-clustered network nodes, and a second clustering process is executed using a different configuration of clustering parameters (e.g., that allows for sparser clusters to be formed). This iterative approach may continue until all possible clusters are formed, effectively handling both dense and sparse regions, and minimizing un-clustered network nodes. Moreover, the iterative clustering approach may conserve significant processing resources relative to executing multiple unrelated clustering operations to determine dense and sparse clusters based on a computationally-expensive trial-and-error approach. The system may assign the resulting clusters to network domains to allow network traffic for a network domain to be processed by the corresponding cluster. For example, dense clusters can be assigned to higher-traffic network domains to provide efficient load balancing and reduced latency, while sparse clusters can be assigned to lower-traffic network domains to conserve network resources and reduce overhead.

Due to the clusters being optimized by the iterative process and accounting for both dense and sparse clusters, the assignments of the clusters to network domains can be used by the system to manage network traffic and allocate network resources efficiently. Moreover, by efficiently clustering network nodes based on local densities, the techniques described herein minimize the number of un-clustered network nodes and optimizes the assignment of clusters to network domains. This results in several benefits, including improved network performance, reduced latency, and enhanced fault tolerance. Additionally, because the iterative clustering approach allows for reduced processing usage, it can be used in real-time environments to dynamically adjust clusters as network conditions change, thereby improving network performance and responsiveness to varying traffic demands.

In some embodiments, a system for distributing network traffic based on network node assignments to network domains, may execute a first process for variable-density-based clustering of a plurality of network nodes of a network using a first configuration of clustering parameters relating to cluster size and cluster density, where the first process is to identify a plurality of first clusters of network nodes that satisfy the first configuration of clustering parameters and a plurality of un-clustered network nodes that do not satisfy the first configuration of clustering parameters. The system may determine one or more clusters of network nodes, of the plurality of first clusters of network nodes, that include network nodes distanced by a threshold network path length. The system may reconfigure (1) the plurality of first clusters of network nodes to remove the one or more clusters of network nodes, and (2) the plurality of un-clustered network nodes to include network nodes of the one or more clusters of network nodes. The system may execute a second process for variable-density-based clustering of the plurality of un-clustered network nodes, as reconfigured, using a second configuration of clustering parameters relating to cluster size and cluster density, where the second process is to identify a plurality of second clusters of network nodes that satisfy the second configuration of clustering parameters, and where the plurality of second clusters differ from the plurality of first clusters by at least cluster density. The system may determine assignments of the plurality of first clusters of network nodes and the plurality of second clusters of network nodes to a plurality of network domains based on data indicating network traffic demands in the plurality of network domains. The system may cause distribution of network traffic from user devices in the plurality of network domains to the plurality of first clusters of network nodes and the plurality of second clusters of network nodes in accordance with the assignments.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIGS. 1A-1D shows an illustrative diagram for distributing network traffic based on network node assignments to network domains, in accordance with one or more embodiments.

FIG. 2 shows illustrative components for a system used to assign network nodes to network domains, in accordance with one or more embodiments.

FIG. 3 shows a flowchart of the steps involved in assigning network nodes to network domains, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

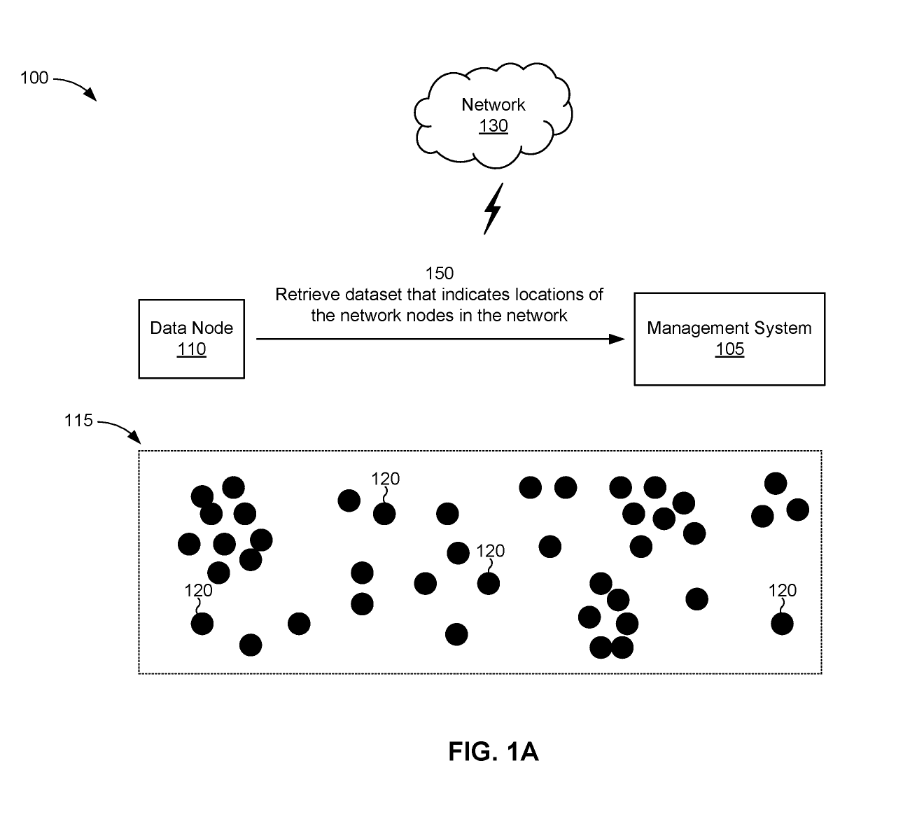

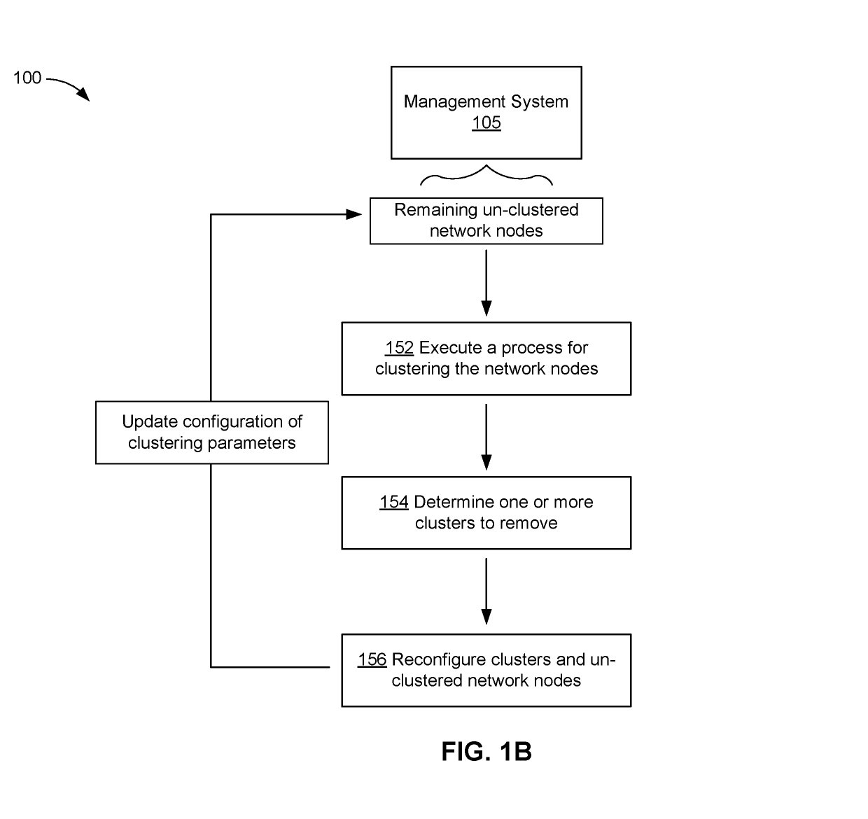

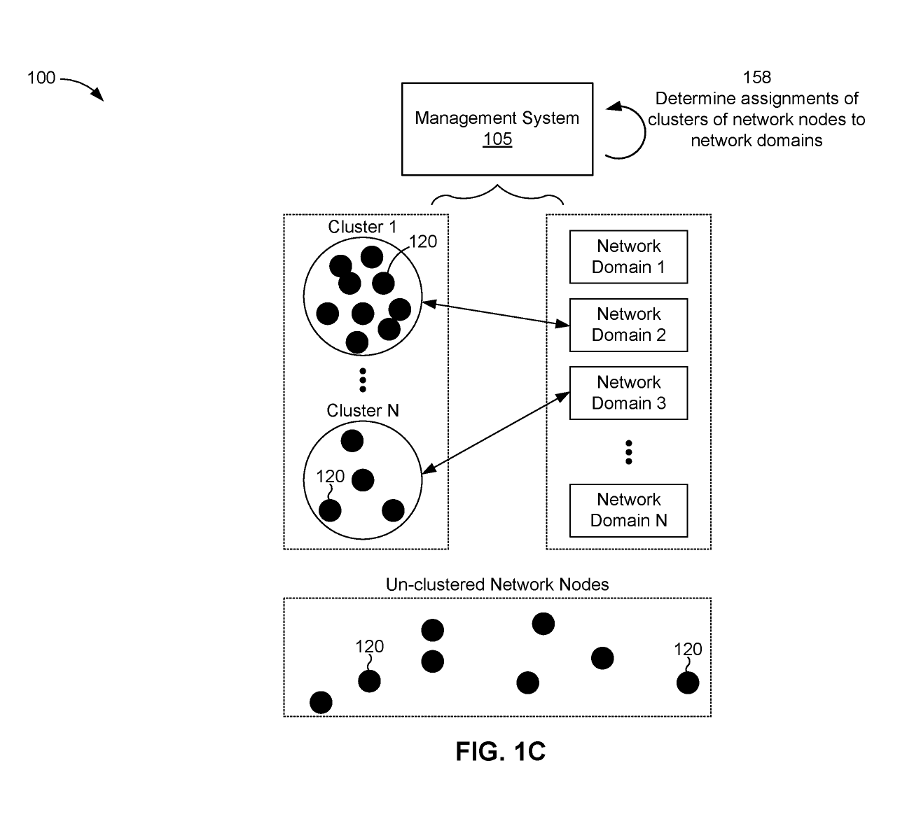

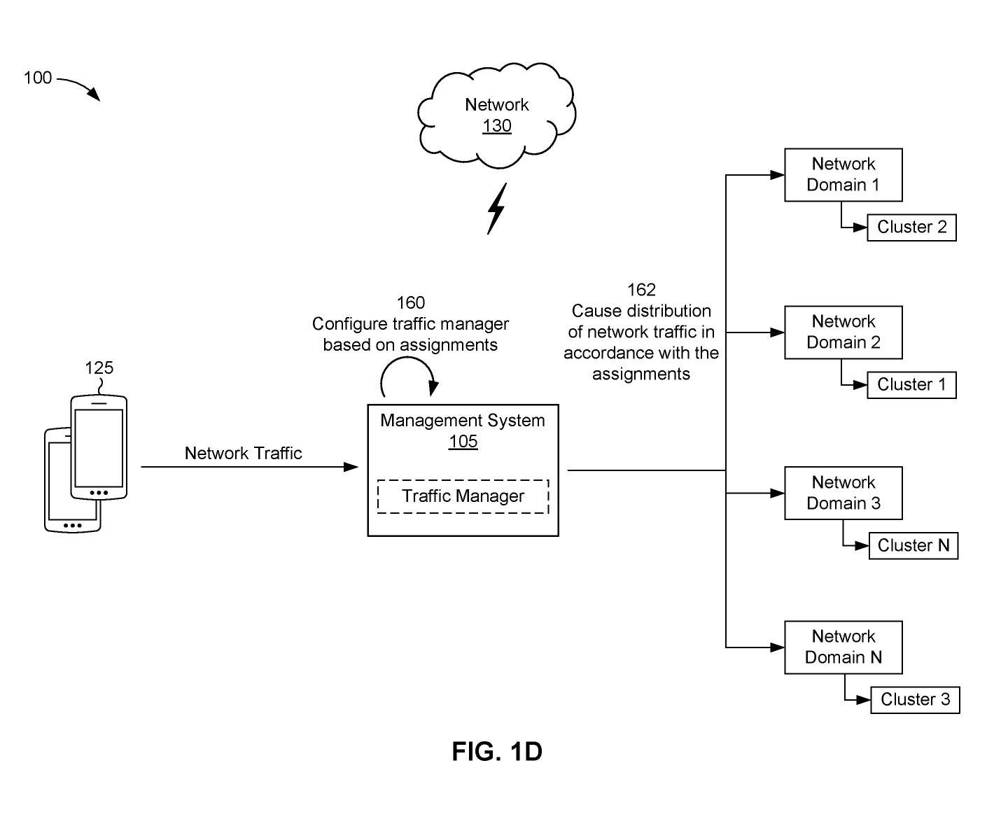

FIGS. 1A-1D show an example environment 100 for distributing network traffic based on network node assignments to network domains, in accordance with one or more embodiments. As shown, the environment 100 includes a management system 105, a data node 110, an operational network 115 that includes a plurality of network nodes 120, one or more user devices 125, and/or a communications network 130.

Communication among the devices and systems of environment 100 may be performed via the communications network 130. The communications network 130 may include one or more wired and/or wireless networks. For example, the communications network 130 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. For example, communications among the devices and systems of environment 100 may be in the form of network messages (e.g., HTTP requests and responses, API requests and responses, or the like).

The data node 110 may include storage, one or more data sources, one or more data services (e.g., accessible via an application programming interface (API)), and/or one or more databases, among other examples. The data node 110 may include, or may be included in, one or more servers. The data node 110 may store information relating to the operational network 115 (e.g., topographical information or inaccessibility information) and/or to the network nodes 120, among other examples. The data node 110 may provide any of the aforementioned information to the management system 105 (e.g., via the communications network 130). In some implementations, the data node 110 may be a component of the management system 105.

The operational network 115 may refer to a system of interconnected network nodes 120 that facilitate the exchange of resources, information, or services across the operational network 115. A network node 120 may refer to an operational entity within the operational network 115 that facilitates the exchange, processing, or distribution of data, resources, or services. The operational network 115 may encompass computer-based networks and/or physical networks. In some embodiments, the operational network 115 may represent a communications infrastructure, where the network nodes 120 correspond to individual servers, data centers, user devices, or other computing resources that distribute and process digital information. For example, the operational network 115 may include data centers (e.g., cloud-based data centers), each represented as a network node 120, where computing workloads are dynamically distributed based on network traffic from user devices. In another example, the operational network 115 may be a content delivery network (CDN) that includes geographically-distributed caching servers acting as network nodes 120 to provide data delivery. As a further example, the operational network 115 may include one or more serving network nodes 120 that implement a resource that can be accessed by, or interacted with by, user network nodes 120 (e.g., user devices). In some embodiments, the operational network 115 may represent a physical infrastructure, where the network nodes 120 correspond to physical locations such as distribution centers or retail locations (e.g., car dealerships) that function as part of a logistical or commercial system. The network nodes 120 may have varying spatial densities. For example, network nodes 120 may not be evenly distributed across a geographic area.

The management system 105 may include a communication device and/or a computing device. For example, the management system 105 may include one or more physical servers, one or more virtual servers (e.g., executing on computing hardware), and/or cloud computing resources (e.g., executing on computing hardware used in a cloud computing environment). In some embodiments, the management system 105 may be implemented on an edge node of a network or of a cloud system (e.g., in a regional data center of the cloud system). In some embodiments, the management system 105 may be a component (e.g., a hardware component or a software component) of a network node 120 or a user device. For example, a user device may exchange data with the management system 105 via a web-based interface (e.g., a web portal). The management system 105 may implement a clustering engine based on a variable-density-based clustering algorithm. For example, the clustering engine may be based on ordering points to identify cluster structure (OPTICS) or another density-based clustering algorithm that can handle clusters of varying densities. A “cluster” may refer to a grouping of network nodes 120 within the operational network 115 that exhibit a defined level of proximity, connectivity, or shared operational characteristics based on given criteria.

The management system 105 may be configured to determine assignments of clusters of network nodes 120 to network domains. A “network domain” may refer to a designated subset of the operational network 115 that includes one or more clusters of network nodes 120, where the network nodes 120 within the network domain share a common operational function, geographic region, or computational resource allocation. For example, a network domain may include a cloud computing region, where a cluster of network nodes 120, such as data centers, process workloads. As another example, a network domain may include a data center, where a cluster of network nodes 120, such as servers, process workloads. As an additional example, a network domain may include a CDN region, where a cluster of network nodes 120, such as caching servers, are deployed to facilitate content distribution. As a further example, a network domain may include a resource to which a cluster of network nodes 120, such as user devices, are given access (e.g., whereas other user devices have their access to the resource restricted). As another example, a network domain may include a fulfillment zone, where a cluster of network nodes 120, such as distribution centers, coordinate inventory storage or other logistical operations. As yet another example, a network domain may include a designated territory, where a cluster of network nodes 120, such as physical locations (e.g., car dealerships), are placed under the management of an assigned agent.

The management system 105 may determine clusters of network nodes 120 in a manner that accounts for the varying spatial densities of the network nodes 120. For example, the management system 105 may perform clustering based on local densities such that both dense and sparse clusters can be identified together. Thus, the management system 105 can efficiently determine the dense and sparse clusters, conserving significant processing resources relative to executing multiple unrelated clustering operations to determine dense and sparse clusters based on a computationally-expensive trial-and-error approach. A “dense” cluster may refer to a grouping of network nodes 120 that are more closely connected or distributed over a smaller area relative to a sparse cluster, whereas a “sparse” cluster may refer to a grouping of network nodes 120 that are more loosely connected or distributed over a wider area relative to a dense cluster.

As shown in FIG. 1A, and by reference number 150, the management system 105 may retrieve a dataset that indicates locations of the network nodes 120 in the network 115. For example, the management system 105 may retrieve the dataset from the data node 110 (e.g., via an API request). The locations of the network nodes 120 may be the physical locations of the network nodes 120 over a geographic area and/or virtual locations of the network nodes 120 within a computing environment. For example, the locations of the network nodes 120 may be indicated by geographic coordinates (e.g., latitude and longitude coordinates), IP addresses, network topology identifiers, logical namespace identifiers, grid coordinates, and/or street addresses, among other examples. In some embodiments, the dataset may indicate activity data associated with the network nodes 120, in which case the locations of the network nodes 120 may refer to their locations on a plot of the activity data.

The management system 105 may employ an iterative process that uses two or more clustering iterations. Reference numbers 152 through 156 describe a single clustering iteration of the process. Thus, this clustering iteration may be performed multiple times as part of the iterative process.

In the clustering iteration, as shown in FIG. 1B, and by reference number 152, the management system 105 may execute a process for clustering (e.g., variable-density-based clustering) the network nodes 120 of the operational network 115 (e.g., using the clustering engine). For example, the process for clustering the network nodes 120 may be based on the locations of the network nodes 120. In particular, the process for clustering the network nodes 120 may be based on distances between the locations of the network nodes 120. In other examples, the process for clustering the network nodes 120 may be based on activity data relating to activities of the network nodes 120 (e.g., user devices) in the operational network 115, such as resources that are accessed, times of accessing resources, frequency of accessing resources, or the like. Here, the process for clustering the network nodes 120 may be based on differences in values (e.g., for a single metric, an aggregate metric, or the like) between each network node’s activity data.

The process for clustering the network nodes 120 may use a configuration of clustering parameters relating to (e.g., affecting) cluster size and cluster density (e.g., which may be adjusted for each iteration, as described herein). For example, the clustering parameters may include a minimum points parameter (e.g., indicating the minimum number of neighbor network nodes 120 to which distances are determined from a given network node 120), a maximum epsilon parameter (e.g., indicating the maximum finite value of a reachability distance, which is the minimum distance at which a network node 120 can be reached from another core network node 120), and/or a minimum cluster size parameter (e.g., indicating the minimum number of network nodes 120 needed to form a cluster), among other examples. The minimum points parameter may affect cluster density, the maximum epsilon parameter may affect cluster size and cluster density, and the minimum cluster size parameter may affect cluster size.

According to the process for clustering, the management system 105 may analyze data points (e.g., network nodes 120) based on their spatial density to create an ordered representation of the dataset’s underlying structure. For example, the management system 105 may construct a reachability plot, which indicates the relative density between points without requiring a predefined number of clusters. Each point is assigned a core distance, representing the minimum radius needed to include a sufficient number of neighboring points (e.g., based on the minimum points parameter), and a reachability distance, which quantifies how closely a point is connected to its neighbors.

To begin the process for clustering, the management system 105 may select an unprocessed point and determine whether that point qualifies as a core point based on the point’s neighborhood density. A core point is a data point that has at least a predefined number of neighboring points (e.g., given by the minimum points parameter) within a given radius (e.g., given by the epsilon parameter), signifying that the core point belongs to a dense region of the dataset. If a point meets this criterion, it is considered a core point and serves as a seed for expanding the cluster. A core distance of a point is the smallest radius needed to enclose a predefined number of neighbors (e.g., given by the minimum points parameter), which provides a measure of the density of the point’s local neighborhood. A reachability distance quantifies the minimum distance required to reach a given point from another point, considering both core distance and direct spatial proximity. In particular, the reachability distance of a point q from a core point p is defined as the greater value between the core distance of p and the direct Euclidean distance between p and q.

As each point is processed, the management system 105 maintains an ordered list of points ranked by their reachability distances. Points with lower reachability distances are more strongly connected to dense regions, while those with high reachability distances represent transitions to sparser areas or potential outliers. This ordering process continues until all points have been processed, resulting in a reachability plot where valleys indicate clusters of varying densities, and peaks represent sparse regions or noise.

As a result of the process for clustering, the management system 105 may identify a plurality of clusters of network nodes 120 that satisfy the configuration of clustering parameters and a plurality of un-clustered network nodes 120 that do not satisfy the configuration of clustering parameters. For example, after the clustering process is performed, multiple clusters may be formed in accordance with the configuration of clustering parameters, however, other network nodes 120 may be left un-clustered because they could not meet the configuration of clustering parameters.

As part of the same clustering iteration, as shown by reference number 154, the management system 105 may determine one or more of the clusters of network nodes 120 to remove from the plurality of clusters. For example, the management system 105 may determine to remove a cluster based on the cluster including network nodes 120 that lack strong interconnectivity. This may be due to the distance between the nodes, network path obstructions between nodes, or other reasons for network paths between nodes being inaccessible.

As an example, the management system 105 may determine that a cluster of the network nodes 120 that includes network nodes distanced by a threshold network path length is to be removed. In particular, the management system 105 may determine distances between all pairs of network nodes 120 in a cluster, determine whether a longest distance of those distances satisfies (e.g., is equal to or greater than) a threshold network path length, and determine to remove the cluster based on determining that the longest distance satisfies the threshold network path length. Thus, clusters with network nodes 120 that are separated by too great of a distance are removed from the plurality of clusters of network nodes 120.

As another example, the management system 105 may determine to remove a cluster based on the cluster including network nodes 120 that have an obstruction between the network nodes 120 (e.g., a physical obstruction, such as a body of water or a mountain, a firewall, or the like) that increases a network path distance between the network nodes 120 (e.g., to be equal to or greater than the threshold network path length). For example, the management system 105 may transmit, to a service endpoint (e.g., an API endpoint), a request for topographical information relating to the operational network 115, and receive, from the service endpoint, the topographical information. The topographical information may indicate a network security configuration of the operational network 115 (e.g., indicating the arrangement of firewalls, security gateways, or virtual private networks (VPNs)) and/or may indicate the physical features of a geographic area that includes the locations of the network nodes 120. The management system 105 may determine, based on the topographical information, a path obstruction between network nodes 120 in a cluster, and determine to remove the cluster based on determining the path obstruction. For example, based on determining the path obstruction, the management system 105 may determine an updated distance between network nodes 120 of the cluster, and determine to remove the cluster based on the updated distance satisfying the threshold network path length.

As a further example, the management system 105 may determine to remove a cluster based on the cluster including network nodes 120 that are inaccessible to each other. For example, the management system 105 may transmit, to a service endpoint (e.g., an API endpoint), a request for inaccessibility information relating to the operational network 115, and receive, from the service endpoint, the inaccessibility information. The inaccessibility information may indicate a network status of the operational network 115 (e.g., indicating damaged network infrastructure, service outages affecting network nodes 120, network nodes 120 that have been taken offline, or the like) and/or may indicate current events affecting the operational network 115 (e.g., natural disasters, border restrictions, or the like). As an example, the inaccessibility information may be news information, weather information, or the like. The management system 105 may determine, based on the inacessibility information, an inaccessible path between network nodes 120 in a cluster, and determine to remove the cluster based on determining the inaccessible path. For example, based on determining the inaccessible path, the management system 105 may determine an updated distance between network nodes 120 of the cluster, and determine to remove the cluster based on the updated distance satisfying the threshold network path length. In some examples, the management system 105 may input the inaccessibility information and information about the clusters and their constituent network nodes 120 (e.g., locations of the network nodes 120) into a machine learning language model (e.g., a large language model) that is trained to identify network nodes 120 that are inaccessible to each other, and the management system 105 may determine the inaccessible path based on an output of the language model.

As further part of the same clustering iteration, as shown by reference number 156, the management system 105 may reconfigure the clusters of network nodes 120 and the un-clustered network nodes 120. In particular, the management system 105 may reconfigure the clusters of network nodes 120 to remove one or more clusters (e.g., that are determined to be removed, as described in connection with reference number 154), and reconfigure the un-clustered network nodes 120 to include the network nodes 120 of the removed clusters. In this way, the management system 105 may un-cluster any clusters that include network nodes 120 that lack strong interconnectivity, as described herein, and add the network nodes 120 of those former clusters back into the pool of un-clustered network nodes 120. The management system 105 may store information indicating the compositions of the clusters of network nodes 120 following the reconfiguration.

The un-clustered network nodes 120 following the reconfiguration may be used in a subsequent clustering iteration. For example, reference numbers 152 through 156 may relate to a first clustering iteration that includes executing a first process for clustering network nodes 120 using a first configuration of clustering parameters, as described herein, and the operations of reference numbers 152 through 156 may be repeated in a second clustering iteration that includes executing a second process for clustering the un-clustered network nodes 120 using a second configuration of clustering parameters. The second process for clustering may identify additional clusters of network nodes 120 that satisfy the second configuration of clustering parameters, as well as un-clustered network nodes 120 that do not satisfy the second configuration of clustering parameters (e.g., which may include fewer un-clustered network nodes 120 than the number of un-clustered network nodes 120 at a start of the second clustering iteration, due to some of the un-clustered network nodes 120 being clustered by the second clustering iteration).

The second configuration of clustering parameters may differ from the first configuration of clustering parameters by at least one parameter. For example, the second configuration of clustering parameters may indicate a different (e.g., smaller) minimum points parameter, a different (e.g., larger) maximum epsilon parameter, and/or a different (e.g., smaller) minimum cluster size parameter than the first configuration of clustering parameters. In one example, the second configuration of clustering parameters may allow for different density (e.g., sparser) clusters than the first configuration of clustering parameters (e.g., the minimum points parameters may be decreased with each clustering iteration). As a result, the clusters of network nodes 120 from the second clustering process may have a different density (e.g., an average density of the clusters) than the clusters of network nodes 120 from the first clustering process (e.g., an average density of the clusters). For example, the clusters of network nodes 120 from the second clustering process may be less dense than the clusters of network nodes 120 from the first clustering process. The density of a cluster may be defined as the number of network nodes 120 per the size of the region occupied by the cluster (e.g., as an area or a volume) or per the sum of reachability distances in the cluster.

As with the first clustering iteration, in the second clustering iteration, the management system 105 may also determine one or more clusters of network nodes 120 to remove (e.g., to un-cluster), and reconfigure the clusters and the un-clustered network nodes 120 accordingly. These resulting un-clustered network nodes 120 may be used for a third clustering iteration that uses a third configuration of clustering parameters different from the first and second configurations, and so forth. In some examples, the iterative process may continue until a maximum number of clustering iterations has been reached (e.g., in accordance with a setting of the management system 105). In other examples, the iterative process may continue until the number of un-clustered network nodes 120 across consecutive clustering iterations stabilizes. For example, at an end of the second clustering iteration, the management system 105 may determine a difference between a quantity of un-clustered network nodes 120 after the second clustering iteration (e.g., either before or after reconfiguration) and a quantity of un-clustered network nodes 120 after the first clustering iteration (e.g., either before or after reconfiguration). Continuing with the example, the management system 105 may determine whether the difference satisfies a threshold (e.g., representing a relatively small number, such as 10 or a number less than 10, that would indicate that the quantity of un-clustered network nodes 120 is remaining relatively stable), and the management system 105 may terminate the iterative process based on determining that the difference satisfies the threshold.

As shown in FIG. 1C, and by reference number 158, the management system 105 may determine assignments and assign the clusters of network nodes 120 (e.g., the clusters formed from the first clustering iteration, the second clustering iteration, etc.) to a plurality of network domains. The management system 105 may determine the assignments based on data indicating network traffic demands in the network domains. For example, the management system 105 may assign clusters formed in the first clustering iteration (e.g., denser clusters) to a network domain associated with higher network traffic demands, and assign clusters formed in the second clustering iteration (e.g., sparser clusters) to a network domain associated with lower network traffic demands. In some embodiments, the management system 105 may retrieve the data from the data node 110 (e.g., the data may be historical data relating to network traffic demands). In some embodiments, the data may indicate current network traffic demands in the network domains (e.g., instantaneous network traffic demands at a time of the assignments). Here, the management system 105 may dynamically perform the iterative process and/or assign clusters to network domains based on the current network traffic demands in the network domains, which may occur periodically or in response to changes in network traffic demands (e.g., demand spikes).

In some embodiments, the management system 105 may generate one or more maps indicating the assignments of the clusters of network nodes 120 to the network domains. For example, a map may include a network topology map, a geographical map (e.g., overlaid with indicators of the assignments), or the like. In some embodiments, the management system 105 may detect anomalies in the operational network 115 based on the un-clustered network nodes 120 that were not part of clusters assigned to network domains. For example, based on there being un-clustered network nodes 120 at a conclusion of the iterative process, the management system 105 may determine that those un-clustered network nodes 120 represent anomalies in the operational network 115, such as malicious network nodes 120 (e.g., user devices exhibiting malicious behavior according to their activity data). Accordingly, the management system 105 may restrict access of these un-clustered network nodes 120 to one or more network resources, while the network nodes 120 in clusters assigned to network domains may access the one or more network resources (e.g., a first cluster of network nodes 120 may be assigned to access a first network domain representing a first network resource, a second cluster of network node 120 may be assigned to access a second network domain representing a second network resource, and so forth). To restrict the access of the un-clustered network nodes 120, the management system 105 may configure an access control policy for the operational network 115, configure a network firewall for the operational network 115, configure a security group for the operational network 115, configure traffic filtering rules for the operational network 115, and/or route traffic associated with the un-clustered network nodes 120 to isolated network segments (e.g., associated with restricted privileges and/or restricted resource access).

The assignments of clusters of network nodes 120 to network domains described and illustrated is provided as an example. The assignments of clusters of network nodes 120 to network domains do not need to follow any particular sequence or order, and can be based on factors such as network traffic demands, as described herein, or other factors such as a location of an assigned agent for a network domain (e.g., a cluster can be assigned to the network domain having an assigned agent that is nearest to a center of the cluster).

As shown in FIG. 1D, and by reference number 160, the management system 105 may configure a traffic manager for the operational network 115 based on assignments of the clusters of network nodes 120 to the network domains. For example, the management system 105 may configure routing policies for the traffic manager, configure load balancing rules for the traffic manager, and/or configure traffic prioritization rules for the traffic manager. The traffic manager may include a router, a routing controller, a network switch, a load balancer, a proxy server, an edge gateway, or the like. The traffic manager may be a component of the management system 105 or a system that the management system 105 can otherwise control.

As shown by reference number 162, the management system 105 may cause distribution (e.g., routing) of network traffic in the network domains to the clusters of network nodes 120 in accordance with the assignments. For example, the management system 105 may cause distribution of network traffic in the network domains using the traffic manager (e.g., that has been configured by the management system 105 based on the assignments). In one example, the management system 105 may cause distribution of network traffic from user devices in the plurality of network domains to the clusters of network nodes 120 in accordance with the assignments (e.g., using the traffic manager).

By using the iterative process described herein, the management system 105 may cluster the network nodes 120 into both sparse and dense clusters in an optimized manner that minimizes the amount of network nodes 120 lacking a cluster. The assignments of the clusters of network nodes 120 to network domains can be used by the management system 105 to manage network traffic and allocate network resources efficiently, thereby enhancing a latency, uptime, and/or fault tolerance of the operational network 115. For example, dense clusters can be assigned to higher-traffic network domains to provide efficient load balancing and reduced latency, while sparse clusters can be assigned to lower-traffic network domains to conserve network resources and reduce overhead. Assigning the clusters to the network domains further enhances network efficiency by enabling domain-specific optimizations, such as region-based traffic routing, hierarchical access control, or domain-specific quality-of-service (QoS) policies. Thus, techniques described herein improve overall network performance, promote efficient use of network resources, and reduce congestion, among other examples.

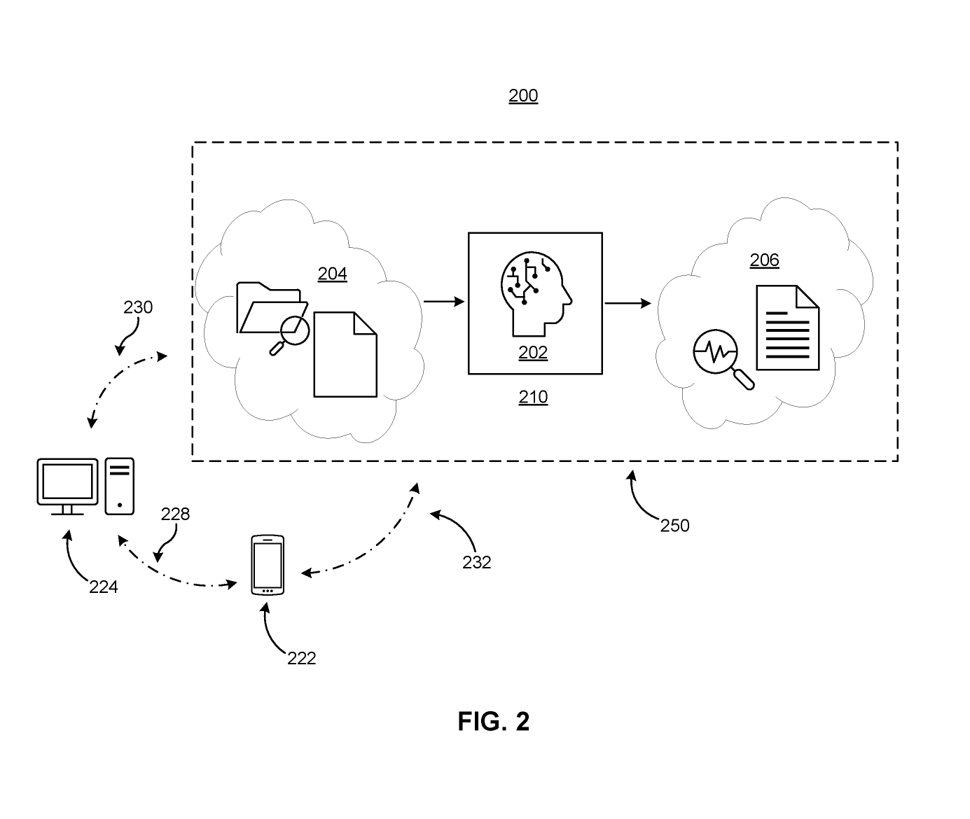

FIG. 2 shows illustrative components for a system used to assign network nodes to network domains, in accordance with one or more embodiments. For example, FIG. 2 may show illustrative components for efficiently distributing network traffic in accordance with assignments of network nodes to network domains. As shown in FIG. 2, system 200 may include mobile device 222 and user terminal 224. While shown as a smartphone and personal computer, respectively, in FIG. 2, it should be noted that mobile device 222 and user terminal 224 may be any computing device, including, but not limited to, a laptop computer, a tablet computer, a hand-held computer, and other computer equipment (e.g., a server), including “smart,” wireless, wearable, and/or mobile devices. FIG. 2 also includes cloud components 210. Cloud components 210 may alternatively be any computing device as described above, and may include any type of mobile terminal, fixed terminal, or other device. For example, cloud components 210 may be implemented as a cloud computing system, and may feature one or more component devices. It should also be noted that system 200 is not limited to three devices. Users may, for instance, utilize one or more devices to interact with one another, one or more servers, or other components of system 200. It should be noted, that, while one or more operations are described herein as being performed by particular components of system 200, these operations may, in some embodiments, be performed by other components of system 200. As an example, while one or more operations are described herein as being performed by components of mobile device 222, these operations may, in some embodiments, be performed by components of cloud components 210. In some embodiments, the various computers and systems described herein may include one or more computing devices that are programmed to perform the described functions. Additionally, or alternatively, multiple users may interact with system 200 and/or one or more components of system 200. For example, in one embodiment, a first user and a second user may interact with system 200 using two different components.

With respect to the components of mobile device 222, user terminal 224, and cloud components 210, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 2, both mobile device 222 and user terminal 224 include a display upon which to display data (e.g., conversational response, queries, and/or notifications).

Additionally, as mobile device 222 and user terminal 224 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 200 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 2 also includes communication paths 228, 230, and 232. Communication paths 228, 230, and 232 may include the Internet, a mobile phone network, a mobile voice or data network (e.g., a 5G or LTE network), a cable network, a public switched telephone network, or other types of communications networks or combinations of communications networks. Communication paths 228, 230, and 232 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 210 may include management system 105, data node 110, and/or network nodes 120. Additionally, or alternatively, cloud components 210 may access data node 110.

Cloud components 210 may include model 202, which may be a machine learning model, artificial intelligence model, etc. (which may be referred collectively as “models” herein). Model 202 may take inputs 204 and provide outputs 206. The inputs may include multiple datasets, such as a training dataset and a test dataset. Each of the plurality of datasets (e.g., inputs 204) may include data subsets related to user data, predicted forecasts and/or errors, and/or actual forecasts and/or errors. In some embodiments, outputs 206 may be fed back to model 202 as input to train model 202 (e.g., alone or in conjunction with user indications of the accuracy of outputs 206, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., an inaccessible path, or a malicious network node 120).

In a variety of embodiments, model 202 may update its configurations (e.g., weights, biases, or other parameters) based on the assessment of its prediction (e.g., outputs 206) and reference feedback information (e.g., user indication of accuracy, reference labels, or other information). In a variety of embodiments, where model 202 is a neural network, connection weights may be adjusted to reconcile differences between the neural network’s prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 202 may be trained to generate better predictions.

In some embodiments, model 202 may include an artificial neural network. In such embodiments, model 202 may include an input layer and one or more hidden layers. Each neural unit of model 202 may be connected with many other neural units of model 202. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 202 may be self-learning and trained, rather than explicitly programmed, and can perform significantly better in certain areas of problem solving, as compared to traditional computer programs. During training, an output layer of model 202 may correspond to a classification of model 202, and an input known to correspond to that classification may be input into an input layer of model 202 during training. During testing, an input without a known classification may be input into the input layer, and a determined classification may be output.

In some embodiments, model 202 may include multiple layers (e.g., where a signal path traverses from front layers to back layers). In some embodiments, back propagation techniques may be utilized by model 202 where forward stimulation is used to reset weights on the “front” neural units. In some embodiments, stimulation and inhibition for model 202 may be more free-flowing, with connections interacting in a more chaotic and complex fashion. During testing, an output layer of model 202 may indicate whether or not a given input corresponds to a classification of model 202 (e.g., an inaccessible path, or a malicious network node 120).

In some embodiments, the model (e.g., model 202) may automatically perform actions based on outputs 206. In some embodiments, the model (e.g., model 202) may not perform any actions. The output of the model (e.g., model 202) may be used to re-cluster network nodes 120 and/or control access to the operational network 115.

System 200 also includes API layer 250. API layer 250 may allow the system to generate summaries across different devices. In some embodiments, API layer 250 may be implemented on mobile device 222 or user terminal 224. Alternatively or additionally, API layer 250 may reside on one or more of cloud components 210. API layer 250 (which may be A REST or Web services API layer) may provide a decoupled interface to data and/or functionality of one or more applications. API layer 250 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 250 may use various architectural arrangements. For example, system 200 may be partially based on API layer 250, such that there is strong adoption of SOAP and RESTful Web-services, using resources like Service Repository and Developer Portal, but with low governance, standardization, and separation of concerns. Alternatively, system 200 may be fully based on API layer 250, such that separation of concerns between layers like API layer 250, services, and applications are in place.

In some embodiments, the system architecture may use a microservice approach. Such systems may use two types of layers: Front-End Layer and Back-End Layer where microservices reside. In this kind of architecture, the role of the API layer 250 may provide integration between Front-End and Back-End. In such cases, API layer 250 may use RESTful APIs (exposition to front-end or even communication between microservices). API layer 250 may use AMQP (e.g., Kafka, RabbitMQ, etc.). API layer 250 may use incipient usage of new communications protocols such as gRPC, Thrift, etc.

In some embodiments, the system architecture may use an open API approach. In such cases, API layer 250 may use commercial or open source API Platforms and their modules. API layer 250 may use a developer portal. API layer 250 may use strong security constraints applying WAF and DDoS protection, and API layer 250 may use RESTful APIs as standard for external integration.

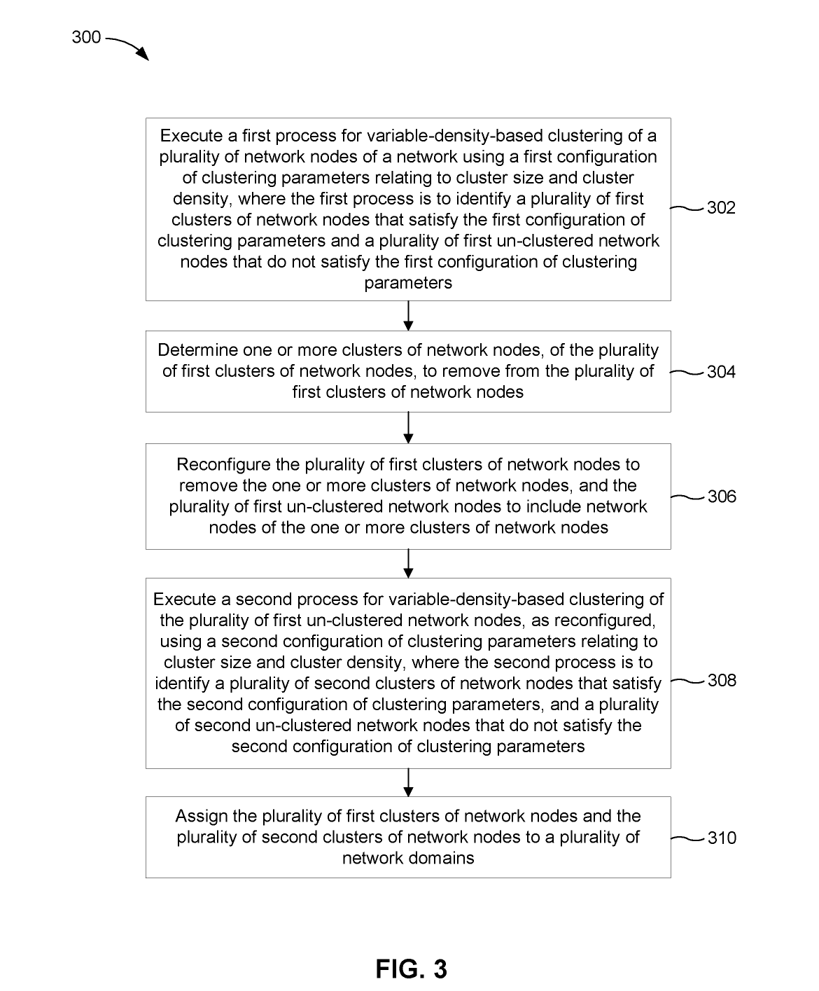

FIG. 3 shows a flowchart of the steps involved in assigning network nodes to network domains in accordance with one or more embodiments. For example, the system may use process 300 (e.g., as implemented on one or more system components described above) in order to efficient distribute network traffic based on assignments of network nodes to network domains.

At step 302, process 300 (e.g., using one or more components described above) may include executing a first process for variable-density-based clustering of a plurality of network nodes of a network. For example, the system may execute a first process for variable-density-based clustering of a plurality of network nodes of a network using a first configuration of clustering parameters relating to cluster size and cluster density, as described herein. For example, as described by reference number 152 of FIG. 1B, the first process may identify a plurality of first clusters of network nodes that satisfy the first configuration of clustering parameters and a plurality of first un-clustered network nodes that do not satisfy the first configuration of clustering parameters. The first process may be a first clustering iteration of an iterative process. The iterative process facilitates clustering of network nodes into both sparse and dense clusters in an optimized manner that minimizes the amount of network nodes lacking a cluster. The iterative process conserves significant processing resources while achieving similar results relative to clustering that is external data-enhanced (e.g., geospatial clustering based on API calls to a maps API).

At step 304, process 300 (e.g., using one or more components described above) may include determining one or more clusters of network nodes to remove from the plurality of first clusters of network nodes. For example, the system may determine one or more clusters of network nodes, of the plurality of first clusters of network nodes, to remove from the plurality of first clusters of network nodes, as described herein. For example, as described in connection with reference number 154 of FIG. 1B, clusters including network nodes that lack strong interconnectivity may be removed. By removing clusters that lack strong interconnectivity between network nodes, the system enhances overall network efficiency and reliability, ensuring that only robust and well-connected clusters are maintained. This reduces latency and improves speeds across the network.

In some embodiments, to determine clusters of network nodes to remove from the plurality of first clusters of network nodes, process 300 may include determining distances between all pairs of network nodes in a cluster of network nodes of the plurality of first clusters of network nodes, determining whether a longest distance of the distances satisfies a threshold network path length, and determining to remove the cluster of network nodes, from the plurality of first clusters of network nodes, based on determining that the longest distance satisfies the threshold network path length. Thus, clusters with network nodes that are separated by too great of a distance are removed from the plurality of first clusters of network nodes. Thus, by doing so, clusters with excessive path lengths are removed, enhancing network performance by maintaining optimal cluster sizes.

In some embodiments, to determine clusters of network nodes to remove from the plurality of first clusters of network nodes, process 300 may include transmitting, to a service endpoint, a request for topographical information relating to the network, receiving, from the service endpoint, the topographical information, determining, based on the topographical information, a path obstruction between network nodes in a cluster of network nodes of the plurality of first clusters of network nodes, and determining to remove the cluster, from the plurality of first clusters of network nodes, based on determining the path obstruction. Identifying and removing clusters with path obstructions improves network reliability by accounting for current network conditions and ensuring that network nodes with currently (e.g., temporary) impractical or inefficient connecting paths are not grouped together.

At step 306, process 300 (e.g., using one or more components described above) may include reconfiguring the plurality of first clusters and the plurality of first un-clustered network nodes. For example, the system may reconfigure the plurality of first clusters of network nodes to remove the one or more clusters of network nodes, and the plurality of first un-clustered network nodes to include network nodes of the one or more clusters of network nodes, as described herein. For example, as described in connection with reference number 156 of FIG. 1B, this provides un-clustering of any clusters that include network nodes that lack strong interconnectivity, and add the network nodes of those former clusters back into the pool of un-clustered network nodes, which allows those network nodes to be considered for re-clustering in a more optimal cluster. By doing so, network topology can be improved by redistributing network nodes for further iterative processing to facilitate clustering that efficiently distributes network nodes and use of network resources.

At step 308, process 300 (e.g., using one or more components described above) may include executing a second process for variable-density-based clustering of the plurality of first un-clustered network nodes as reconfigured. For example, the system may execute a second process for variable-density-based clustering of the plurality of first un-clustered network nodes, as reconfigured, using a second configuration of clustering parameters relating to cluster size and cluster density, as described herein. For example, the second process may identify a plurality of second clusters of network nodes that satisfy the second configuration of clustering parameters, and a plurality of second un-clustered network nodes that do not satisfy the second configuration of clustering parameters. The second process may be a second clustering iteration of the iterative process. The iterative process facilitates clustering of network nodes into both sparse and dense clusters in an optimized manner that minimizes the amount of network nodes lacking a cluster. The iterative process conserves significant processing resources while achieving similar results relative to clustering that is external data-enhanced (e.g., geospatial clustering based on API calls to a maps API). The second configuration of clustering parameters allowing for sparser clusters than the first configuration of clustering parameters. Thus, the iterative process may progressively adjust clustering parameters to allow for sparser clusters to enhance scalability and adaptability by first identifying tightly connected network nodes before expanding to capture more loosely associated nodes. This approach ensures that both dense and sparse structures within the network are efficiently detected, reducing fragmentation while enabling multi-resolution clustering that supports optimized resource allocation and hierarchical network organization.

In some embodiments, process 300 may include retrieving a dataset indicating locations of the plurality of network nodes in the network, wherein the first process and the second process are based on distances between the locations. The dataset enhances clustering precision by leveraging structured and reliable location data, ensuring that the clustering process is based on accurate and consistent information. In some embodiments, process 300 may include determining that a difference between a quantity of the plurality of second un-clustered network nodes and a quantity of the plurality of first un-clustered network nodes satisfies a threshold, and terminating the iterative process based on determining that the difference satisfies the threshold. In this way, unnecessary iterations can be eliminated once the clustering process reaches a stable state, thereby reducing redundant computations and conserving processing resources.

At step 310, process 300 (e.g., using one or more components described above) may include assigning the plurality of first clusters of network nodes and the plurality of second clusters of network nodes. For example, the system may assign the plurality of first clusters of network nodes and the plurality of second clusters of network nodes to a plurality of network domains, as described herein. For example, as described in connection with reference number 158 of FIG. 1C, the assignments may based on data indicating network traffic demands in the network domains. In this way, the network capacity may be aligned with demand patterns, thereby providing efficient resource utilization. By doing so, network performance and scalability may be improved by allowing the system to adaptively allocate bandwidth, processing power, and routing priorities within each network domain, reducing congestion and improving overall service quality.

In some embodiments, process 300 may include generating a map indicating assignments of the plurality of first clusters of network nodes and the plurality of second clusters of network nodes to the plurality of network domains. Doing so facilitates network visualization and network domain management. In some embodiments, process 300 may include configuring a traffic manager for the network based on assignments of the plurality of first clusters of network nodes and the plurality of second clusters of network nodes to the plurality of network domains, and causing distribution of network traffic from user devices in the plurality of network domains using the traffic manager. By doing so, the system can optimize traffic flow and load balancing by directing network traffic based on cluster assignments, thereby reducing latency, preventing congestion, and improving overall network efficiency and responsiveness. In some embodiments, process 300 may include determining that the plurality of second un-clustered network nodes represent anomalies, and restricting access of the plurality of second un-clustered network nodes to one or more network resources. By doing so, the system enhances network security and resource integrity by preventing anomalous or potentially malicious network nodes from accessing resources, thereby reducing the risk of unauthorized access, data breaches, or network disruptions, and conserving processing resources that otherwise may be allocated to identifying, preventing, and/or remediating malicious activity.

It is contemplated that the steps or descriptions of FIG. 3 may be used with any other embodiment of this disclosure. In addition, the steps and descriptions described in relation to FIG. 3 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 3.

In some implementations, an Application-Specific Integrated Circuit (ASIC) may be configured to perform operations described herein. An ASIC is a specialized hardware chip designed to perform a specific task or set of tasks with high efficiency. Unlike general-purpose processors, such as CPUs or GPUs, ASICs are custom-built for particular applications, optimizing performance, power consumption, and area efficiency. ASICs are widely used in areas such as cryptocurrency mining, telecommunications, and artificial intelligence (AI), where dedicated hardware can provide significant advantages over more flexible but less efficient alternatives. Implementing a large AI model in an ASIC requires designing custom circuits that accelerate the model’s computations while ensuring efficient memory management and data movement. Because AI models, particularly deep learning networks, involve extensive matrix multiplications and tensor operations, specialized hardware units such as systolic arrays or tensor processing units (TPUs) can be integrated to optimize these operations. To overcome this challenge, the system may use weight quantization, memory hierarchy optimization, and on-chip interconnects can be employed to improve throughput and reduce power consumption. To accommodate large models, the system may integrate high-bandwidth memory (HBM) or leverage chiplet architectures, where multiple ASICs work together in a modular fashion to process different portions of the model. Training AI models on an ASIC presents significant challenges since training involves dynamic weight updates and high computational flexibility, which contrasts with the fixed nature of ASICs. To do so, the system may use field-programmable gate arrays (FPGAs) or GPUs during the training phase, then transfer the trained model weights to the ASIC for inference. Alternatively, the system may design ASICs that support on-chip fine-tuning or low-bit precision training, allowing for limited retraining directly on the device. Additionally, co-designing hardware and algorithms ensures that the model architecture is tailored to the ASIC’s capabilities, reducing inefficiencies and maximizing performance. By integrating specialized training accelerators, approximate computing methods, and efficient dataflow architectures, ASICs can be optimized for both training and inference, enabling large AI models to operate with minimal energy and latency constraints.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for network node assignment to network domains.
2. The method of embodiment 1 comprising: executing, by a device, a first process for variable-density-based clustering of a plurality of network nodes of a network using a first configuration of clustering parameters relating to cluster size and cluster density, wherein the first process is to identify a plurality of first clusters of network nodes that satisfy the first configuration of clustering parameters and a plurality of first un-clustered network nodes that do not satisfy the first configuration of clustering parameters; determining, by the device, one or more clusters of network nodes, of the plurality of first clusters of network nodes, to remove from the plurality of first clusters of network nodes; reconfiguring, by the device, (1) the plurality of first clusters of network nodes to remove the one or more clusters of network nodes, and (2) the plurality of first un-clustered network nodes to include network nodes of the one or more clusters of network nodes; executing, by the device, a second process for variable-density-based clustering of the plurality of first un-clustered network nodes, as reconfigured, using a second configuration of clustering parameters relating to cluster size and cluster density, wherein the second process is to identify a plurality of second clusters of network nodes that satisfy the second configuration of clustering parameters, and a plurality of second un-clustered network nodes that do not satisfy the second configuration of clustering parameters; and assigning, by the device, the plurality of first clusters of network nodes and the plurality of second clusters of network nodes to a plurality of network domains.
3. The method of any of embodiments 1-2, further comprising: generating a map indicating assignments of the plurality of first clusters of network nodes and the plurality of second clusters of network nodes to the plurality of network domains.
4. The method of any of embodiments 1-3, wherein determining the one or more clusters of network nodes to remove from the plurality of first clusters of network nodes comprises: determining distances between all pairs of network nodes in a cluster of network nodes of the plurality of first clusters of network nodes; determining whether a longest distance of the distances satisfies a threshold network path length; and determining to remove the cluster of network nodes, from the plurality of first clusters of network nodes, based on determining that the longest distance satisfies the threshold network path length.
5. The method of any of embodiments 1-4, wherein determining the one or more clusters of network nodes to remove from the plurality of first clusters of network nodes comprises: transmitting, to a service endpoint, a request for topographical information relating to the network; receiving, from the service endpoint, the topographical information; determining, based on the topographical information, a path obstruction between network nodes in a cluster of network nodes of the plurality of first clusters of network nodes; and determining to remove the cluster, from the plurality of first clusters of network nodes, based on determining the path obstruction.
6. The method of any of embodiments 1-5, wherein determining the one or more clusters of network nodes to remove from the plurality of first clusters of network nodes comprises: transmitting, to a service endpoint, a request for inacessibility information relating to the network; receiving, from the service endpoint, the inacessibility information; determining, based on the inacessibility information, an inaccessible path between network nodes in a cluster of network nodes of the plurality of first clusters of network nodes; and determining to remove the cluster, from the plurality of first clusters of network nodes, based on determining the inaccessible path.
7. The method of any of embodiments 1-6, wherein the first process is a first clustering iteration of an iterative process, the second process is a second clustering iteration of an iterative process, and the method further comprises: determining that a difference between a quantity of the plurality of second un-clustered network nodes and a quantity of the plurality of first un-clustered network nodes satisfies a threshold; and terminating the iterative process based on determining that the difference satisfies the threshold.
8. The method of any of embodiments 1-7, further comprising: determining one or more additional clusters of network nodes, of the plurality of second clusters of network nodes, to remove from the plurality of second clusters of network nodes; and reconfiguring the plurality of second clusters of network nodes to remove the one or more additional clusters of network nodes, and the plurality of second un-clustered network nodes to include network nodes of the one or more additional clusters of network nodes.
9. The method of any of embodiments 1-8, further comprising: retrieving a dataset indicating locations of the plurality of network nodes in the network, wherein the first process and the second process are based on distances between the locations.
10. The method of any of embodiments 1-9, wherein the second configuration of clustering parameters allow for sparser clusters than the first configuration of clustering parameters.
11. The method of any of embodiments 1-10, further comprising: configuring a traffic manager for the network based on assignments of the plurality of first clusters of network nodes and the plurality of second clusters of network nodes to the plurality of network domains; and causing distribution of network traffic from user devices in the plurality of network domains using the traffic manager.
12. The method of any of embodiments 1-11, further comprising: determining that the plurality of second un-clustered network nodes represent anomalies; and restricting access of the plurality of second un-clustered network nodes to one or more network resources.
13. One or more non-transitory, computer-readable mediums storing instructions that, when executed by a data processing apparatus, cause the data processing apparatus to perform operations comprising those of any of embodiments 1-12.
14. A system comprising one or more processors; and memory storing instructions that, when executed by the processors, cause the processors to effectuate operations comprising those of any of embodiments 1-12.
15. A system comprising means for performing any of embodiments 1-12.

What is claimed is:

1. A system for distributing network traffic based on network node assignments to network domains, the system comprising:
one or more memories; and
one or more processors, communicatively coupled to the one or more memories, configured to cause the system to:
execute a first process for variable-density-based clustering of a plurality of network nodes of a network using a first configuration of clustering parameters relating to cluster size and cluster density,
wherein the first process is to identify a plurality of first clusters of network nodes that satisfy the first configuration of clustering parameters and a plurality of un-clustered network nodes that do not satisfy the first configuration of clustering parameters;
determine one or more clusters of network nodes, of the plurality of first clusters of network nodes, that include network nodes distanced by a threshold network path length;
reconfigure (1) the plurality of first clusters of network nodes to remove the one or more clusters of network nodes, and (2) the plurality of un-clustered network nodes to include network nodes of the one or more clusters of network nodes;
execute a second process for variable-density-based clustering of the plurality of un-clustered network nodes, as reconfigured, using a second configuration of clustering parameters relating to cluster size and cluster density,
wherein the second process is to identify a plurality of second clusters of network nodes that satisfy the second configuration of clustering parameters, and
wherein the plurality of second clusters differ from the plurality of first clusters by at least cluster density;
determine assignments of the plurality of first clusters of network nodes and the plurality of second clusters of network nodes to a plurality of network domains based on data indicating network traffic demands in the plurality of network domains; and
cause distribution of network traffic from user devices in the plurality of network domains to the plurality of first clusters of network nodes and the plurality of second clusters of network nodes in accordance with the assignments.

2. A method for network node assignment to network domains, the method comprising:
executing, by a device, a first process for variable-density-based clustering of a plurality of network nodes of a network using a first configuration of clustering parameters relating to cluster size and cluster density,
wherein the first process is to identify a plurality of first clusters of network nodes that satisfy the first configuration of clustering parameters and a plurality of first un-clustered network nodes that do not satisfy the first configuration of clustering parameters;
determining, by the device, one or more clusters of network nodes, of the plurality of first clusters of network nodes, to remove from the plurality of first clusters of network nodes;
reconfiguring, by the device, (1) the plurality of first clusters of network nodes to remove the one or more clusters of network nodes, and (2) the plurality of first un-clustered network nodes to include network nodes of the one or more clusters of network nodes;
executing, by the device, a second process for variable-density-based clustering of the plurality of first un-clustered network nodes, as reconfigured, using a second configuration of clustering parameters relating to cluster size and cluster density,
wherein the second process is to identify a plurality of second clusters of network nodes that satisfy the second configuration of clustering parameters, and a plurality of second un-clustered network nodes that do not satisfy the second configuration of clustering parameters; and
assigning, by the device, the plurality of first clusters of network nodes and the plurality of second clusters of network nodes to a plurality of network domains.

3. The method of claim 2, further comprising:
generating a map indicating assignments of the plurality of first clusters of network nodes and the plurality of second clusters of network nodes to the plurality of network domains.

4. The method of claim 2, wherein determining the one or more clusters of network nodes to remove from the plurality of first clusters of network nodes comprises:
determining distances between all pairs of network nodes in a cluster of network nodes of the plurality of first clusters of network nodes;
determining whether a longest distance of the distances satisfies a threshold network path length; and
determining to remove the cluster of network nodes, from the plurality of first clusters of network nodes, based on determining that the longest distance satisfies the threshold network path length.

5. The method of claim 2, wherein determining the one or more clusters of network nodes to remove from the plurality of first clusters of network nodes comprises:
transmitting, to a service endpoint, a request for topographical information relating to the network;
receiving, from the service endpoint, the topographical information;
determining, based on the topographical information, a path obstruction between network nodes in a cluster of network nodes of the plurality of first clusters of network nodes; and
determining to remove the cluster, from the plurality of first clusters of network nodes, based on determining the path obstruction.

6. The method of claim 2, wherein determining the one or more clusters of network nodes to remove from the plurality of first clusters of network nodes comprises:
transmitting, to a service endpoint, a request for inacessibility information relating to the network;
receiving, from the service endpoint, the inacessibility information;
determining, based on the inacessibility information, an inaccessible path between network nodes in a cluster of network nodes of the plurality of first clusters of network nodes; and
determining to remove the cluster, from the plurality of first clusters of network nodes, based on determining the inaccessible path.

7. The method of claim 2, wherein the first process is a first clustering iteration of an iterative process, the second process is a second clustering iteration of an iterative process, and the method further comprises:
determining that a difference between a quantity of the plurality of second un-clustered network nodes and a quantity of the plurality of first un-clustered network nodes satisfies a threshold; and
terminating the iterative process based on determining that the difference satisfies the threshold.

8. The method of claim 2, further comprising:
determining one or more additional clusters of network nodes, of the plurality of second clusters of network nodes, to remove from the plurality of second clusters of network nodes; and
reconfiguring the plurality of second clusters of network nodes to remove the one or more additional clusters of network nodes, and the plurality of second un-clustered network nodes to include network nodes of the one or more additional clusters of network nodes.

9. The method of claim 2, further comprising:
retrieving a dataset indicating locations of the plurality of network nodes in the network,
wherein the first process and the second process are based on distances between the locations.

10. The method of claim 2, wherein the second configuration of clustering parameters allow for sparser clusters than the first configuration of clustering parameters.

11. The method of claim 2, further comprising:
configuring a traffic manager for the network based on assignments of the plurality of first clusters of network nodes and the plurality of second clusters of network nodes to the plurality of network domains; and
causing distribution of network traffic from user devices in the plurality of network domains using the traffic manager.

12. The method of claim 2, further comprising:
determining that the plurality of second un-clustered network nodes represent anomalies; and
restricting access of the plurality of second un-clustered network nodes to one or more network resources.

13. A non-transitory, computer-readable medium, comprising instructions that, when executed by one or more processors, cause operations comprising:
executing a first process for variable-density-based clustering of a plurality of network nodes of a network using a first configuration of clustering parameters relating to cluster size and cluster density,
wherein the first process is to identify a plurality of first clusters of network nodes that satisfy the first configuration of clustering parameters and a plurality of first un-clustered network nodes that do not satisfy the first configuration of clustering parameters;
removing one or more clusters of network nodes, of the plurality of first clusters of network nodes, from the plurality of first clusters of network nodes, and adding network nodes of the one or more clusters to the plurality of first un-clustered network nodes; and
executing a second process for variable-density-based clustering of the plurality of first un-clustered network nodes using a second configuration of clustering parameters relating to cluster size and cluster density,
wherein the second process is to identify a plurality of second clusters of network nodes that satisfy the second configuration of clustering parameters, and a plurality of second un-clustered network nodes that do not satisfy the second configuration of clustering parameters.

14. The non-transitory, computer-readable medium of claim 13, wherein the instructions, when executed by the one or more processors, further cause operations comprising:
generating a map indicating assignments of the plurality of first clusters of network nodes and the plurality of second clusters of network nodes to a plurality of network domains.

15. The non-transitory, computer-readable medium of claim 13, wherein removing the one or more clusters of network nodes comprises:
determining distances between all pairs of network nodes in a cluster of network nodes of the plurality of first clusters of network nodes;
determining whether a longest distance of the distances satisfies a threshold network path length; and
determining to remove the cluster of network nodes, from the plurality of first clusters of network nodes, based on determining that the longest distance satisfies the threshold network path length.

16. The non-transitory, computer-readable medium of claim 13, wherein removing the one or more clusters of network nodes comprises:
transmitting, to a service endpoint, a request for topographical information relating to the network;
receiving, from the service endpoint, the topographical information;
determining, based on the topographical information, a path obstruction between network nodes in a cluster of network nodes of the plurality of first clusters of network nodes; and
determining to remove the cluster, from the plurality of first clusters of network nodes, based on determining the path obstruction.

17. The non-transitory, computer-readable medium of claim 13, wherein removing the one or more clusters of network nodes comprises:
transmitting, to a service endpoint, a request for inacessibility information relating to the network;
receiving, from the service endpoint, the inacessibility information;
determining, based on the inacessibility information, an inaccessible path between network nodes in a cluster of network nodes of the plurality of first clusters of network nodes; and
determining to remove the cluster, from the plurality of first clusters of network nodes, based on determining the inaccessible path.

18. The non-transitory, computer-readable medium of claim 13, wherein the first process is a first clustering iteration of an iterative process, the second process is a second clustering iteration of an iterative process, and the instructions, when executed by the one or more processors, further cause operations comprising:
determining that a difference between a quantity of the plurality of second un-clustered network nodes and a quantity of the plurality of first un-clustered network nodes satisfies a threshold; and
terminating the iterative process based on determining that the difference satisfies the threshold.

19. The non-transitory, computer-readable medium of claim 13, wherein the instructions, when executed by the one or more processors, further cause operations comprising:
configuring a traffic manager for the network based on assignments of the plurality of first clusters of network nodes and the plurality of second clusters of network nodes to a plurality of network domains; and
causing distribution of network traffic from user devices in the plurality of network domains using the traffic manager.

20. The non-transitory, computer-readable medium of claim 13, wherein the instructions, when executed by the one or more processors, further cause operations comprising:
determining that the plurality of second un-clustered network nodes represent anomalies; and
restricting access of the plurality of second un-clustered network nodes to one or more network resources.
